(19) United States
(12) Patent Application Publication
(10) Pub. No.: US 2010/0138049 A1
(43) Pub. Date: Jun. 3, 2010

(54) ENVIRONMENTAL CONTROL UNIT FOR HARSH CONDITIONS

(75) Inventors: John L. Creed, Niles, OH (US); Steven G. Skinner, Willoughby, OH (US); Robert K. Crowder, Eagle Rock, VA (US)

Correspondence Address: FAY SHARPE LLP, 1228 Euclid Avenue, 5th Floor, The Halle Building, Cleveland, OH, 44115, US

(73) Assignee: Hunter Manufacturing Co.

(21) Appl. No.: 12/640,570

(22) Filed: Dec. 17, 2009

Related U.S. Application Data
(62) Division of application No. 11/789,252, filed on Apr. 24, 2007.

(51) Int. Cl. G05B 15/00

(52) U.S. Cl. 700/276

(57) ABSTRACT

A method of controlling an air conditioning system of the type having a variable capacity compressor circulating refrigerant through a condenser, an expander, an evaporator and returning to the compressor. Sensors are disposed to sense a refrigerant condition selected from one of pressure and temperature on one or both the compressor high pressure and low pressure side; and, in the event of an overload condition, the sensors generate a control signal that effects operation of an actuator for moving a member in the compressor to vary the compressor capacity to the lowest capacity output. Alternatively, the generated control signal may vary the compressor speed.

### BACKGROUND

The present disclosure generally relates to methods and arrangements of components that prevent high-pressure shutdown during loads that can exceed the design load, or designed saturated condenser temperature or condenser coil condition of a field deployable, mobile, Environmental Control Unit (ECU).

In military applications where transport bulk and weight are at a costly premium, simply enlarging ECU's for greater capacity is unacceptable. Heretofore, attempts have been made to reduce the size and weight of ECU's and produce a lighter, smaller, more efficient unit. The effort has primarily been focused on known techniques such as hot gas by-pass and fixed capacity compressors, in a smaller frame or enclosure.

ECU's for military use differ from non military air conditioning systems. An ECU for military service is designed for withstanding induced vibration from ship, air, and ground transportation, particularly when stacked with other units. Additionally, lifting provisions must be provided for helicopter sling transport; and, the units must withstand dropping, 40 Mph winds with 4 inches per hour rain, must be able to operate on both 60 and 50 hertz alternating current with limited compressor starts and must be capable of being operated on un-prepared or rough terrain. In military service, the operational extremes can vary from severe cold, snow and freezing rain to above 145° F. combined ground solar and ambient load. Military service units must also withstand tropical, desert, and high altitude conditions. Each ECU intended for military field service is developed for a specific capacity and application; however, once fielded, will be required to operate when attached to any tent or hard wall structure. It has been difficult to match ECU capacity to the load due to the various field tent and hard wall shelter variations. These structures vary in insulation factor, fenestration, and the type of air distribution system employed. Thermal loads and evaporator air flow can vary to an extent that the known evaporator de-rating techniques, such as hot gas by-pass and compressor suction cooling are inefficient. In many cases, it has been found such techniques cannot provide the range of control necessary to prevent component degradation or provide consistent ECU operation.

In such military applications, the ECU can be a split design, with the evaporator inside the area to be cooled with the condenser and compressor section outside; or, all components can be contained within a single enclosure. ECU's for military applications are generally powered by portable generators, but may be connected to a local power grid when such is available. Examples of the range of refrigerants used are HCFC-22, HFC-134a and R410A, R407C. Current ECU's have compressors with fixed capacity output. Load capacities of an ECU generally range from about 9,000 BTU to about 100,000 BTU. The most commonly used ECU's have a capacity of about 60,000 BTU.

In an attempt to retain design airflow, ECU condensers and evaporators are provided with screens and filters to protect them from debris. Particulate matter encountered in military field usage can vary from blown organic plant matter, such as grasses or trees, to foot and vehicle generated sand and dust, to climatic sand and dust storms. Restriction of condenser airflow from sand and dust is a frequent field occurrence. The dust that is removed from condensers and evaporators has the consistency of talc and passes easily through the screens and filters, clogging coils and reducing airflow.

Currently, there is no method of preventing sand and dust from causing coil airflow restriction in a unit, in a manner that will meet space volume and electrical power draw requirements. For operation in high ambient solar temperatures, some manufacturers have included a sun shield or fly to reduce the solar load on the ECU, in an attempt to reduce compressor high side system pressures. Also, coils are being cleaned more frequently; however, with so many ECU's in the field, this takes time and cannot always be done in a timely manner.

Another ECU problem is the cost of providing diesel fuel for power generation in the field. Fuel cost can easily exceed $30.00 per gallon on site. Current ECU technology uses hot gas bypass, to de-rate or reduce the efficiency of the evaporator during low load conditions. The by-pass of gas can be before or after the evaporator. This fluid by-pass is not used for cooling but uses compressor energy to pump it. Such non-cooling load on the compressor is disadvantageous because it results in costly increased diesel fuel consumption.

These aforesaid refrigerant management techniques have added to the complexity of the ECU in view of the requirement for the additional piping, valves and fittings. They have also resulted in increased system leaks, inoperable units and increased maintenance. Furthermore, the gas by-pass approach does not adequately regulate the system when the condenser is restricted, or during ECU operation under high ambient conditions when the load exceeds the design load. This results in frequent nuisance shut downs, due to overpressure conditions at the compressor discharge.

One approach to addressing the described problems is disclosed in U.S. Pat. No. 6,047,557; U.S. Pat. No. 6,601,397 B2; International Publication Number WO 2006/014079 A1 and U.S. Pat. Publication 2005/0189888 A1 the disclosures of which are incorporated herein by reference in their entireties. These patents show the components of the compressors and how they work. The solution presented in the above patents is that of using a variable capacity type scroll compressor that is able to load and unload to vary the capacity. Other methods use variable speed compressor drive converters that provide scroll or rotary compressor RPM controls for changing the capacity output of a compressor. Although the techniques described in the aforesaid patents have been used in commercial refrigeration applications and in unitary air conditioners for the commercial market, such systems have not been able to meet the special operational, maintenance, and sustainment cost requirements for a military field deployable ECU.

U.S. Patent Publication 2005/0189888 A1 refers to a variable speed drive of compressors; and, U.S. Pat. No. 6,047,557 refers to a pulse width modulating duty cycle. Each has the ability to be temperature controlled by an operator selectable thermostat input with additional pressure and temperature sensor connection locations.

It has been proposed to employ an inverter driven compressor for an ECU application; however, the inverter or variable frequency drive is complicated to diagnose and creates high levels of Electro Magnetic Interference. EMI is also costly to shield.

In military applications, ECU's are often required to operate in high ambient conditions with blowing sand and dust. In order to meet recently increased demand for military service applications, commercially available and modified commercial air conditioners have been employed in military usage. In desert environments, the modified commercial air conditioners have frequently shut down due to over pressure. Such units employed in desert environments have also experienced high failure rates of compressors, contactors and function controllers. These failures have been attributed to prolonged operation at elevated system pressure and subsequent high compressor motor current draw. The cost and effort required to provide routine maintenance and repair has thus been increased. Furthermore, where non-military contractors are hired to perform maintenance, if their contract cost is exceeded, maintenance and repair work is stopped until contract cost issues are resolved, resulting in periods of inoperation.

Current ECU and fielded commercial air conditioners do not have the ability to reduce capacity during excessive high ambient conditions or when operated with reduced condenser air flow, caused by sand and dust loading. Loss of cooling and additional maintenance is created from high-pressure induced short cycling, i.e., when the compressor overload pressure switch trips on high-pressure. Some designs will automatically reset, and others need to be manually reset. High temperature starting and stopping of the compressor under load also decreases the life of the compressor. Repetitive starting and stopping of compressors can also create power line problems when powered by a mobile generator; and, the loss of cooling can also be life threatening in a field hospital application.

It has thus been desired to provide a lighter, smaller, more efficient ECU that self regulates capacity based on indoor and outside temperatures, indoor air distribution airflows and evaporator and condenser coil heat transfer conditions without shut downs due to overpressure.

However, when compressor high side capacity is exceeded, currently the compressor is simply shut down. This is disadvantageous for the reasons detailed above. Accordingly, it has been deemed desirable to develop a new and improved environmental control unit which would overcome the foregoing difficulties and others while providing better and more advantageous overall results.

### SUMMARY

The subject matter of the present disclosure integrates a variable capacity compressor with pressure and temperature sensors to modulate system capacity based on component condition, ambient temperatures, and airflows. This variable capacity system control, self regulates, during over capacity and under capacity conditions, to the maximum cooling capacity obtainable using less power than systems currently available in ECU's utilized in military field service.

More specifically, the present disclosure relates to the use of variable capacity compressors and methods to provide voltage control input to the variable capacity compressor controller or inverter. This eliminates the need for hot gas by-pass, which is inefficient during low load conditions, and provides an alternative to compressor suction side quenching and similar refrigerant management schemes that have increased the occurrence of refrigerant leaks.

The present system maintains ECU operation during out-of-design tolerance operation such as operation with high condenser pressure, low evaporator pressure and excessive compressor inlet temperature. The presently disclosed adaptive control provides a variable voltage output signal to operate commercially available compressor controllers that vary the compressor capacity (such as digital scroll) or the speed of the compressor (such as variable frequency drive or inverter). This adaptive input provides automatic ECU balancing when used in an environmentally severe or military application, matching variable cooling capacity based on maximum heat transfer of the evaporator or condenser and protects the compressor inlet temperature.

This disclosure describes and illustrates a system with the ability to vary the system high and low side pressures and temperatures, coupled with providing thermostat input to a digital or variable speed compressor drive controller. The compressor capacity can be reduced during low load conditions, caused by cool ambient conditions or a restricted evaporator coil. The present system has the ability to lower the compressor capacity to match the load and prevents frost or evaporator freeze up, and reduces energy related costs compared to a system employing hot gas by-pass. By reducing compressor output to match the heat rejection capabilities of the condenser, where condenser airflow has become restricted, compressor cut-off due to high pressure is eliminated. During high evaporator load conditions, when the suction gas temperature exceeds the manufacturer's design limits, the compressor capacity can be changed to lower the suction temperature thereby saving energy. Contrasted with systems which use hot gas by-pass and quench type refrigerant management resulting in additional components, associated tubing and fittings with greater potential leak points, this disclosure presents a system that reduces generator fuel or electric grid cost, is simple to understand and repair while using fewer components.

In one embodiment, the sensors may generate a signal to a controller which operates an actuator for effecting movement of a member in the compressor for varying compressor capacity. In another embodiment, the sensors may generate a signal to a controller which effects compressor speed changes to vary the capacity. In a sensed overload condition, the generated signal effects varying the compressor capacity to the lowest capacity output condition.

### BRIEF DESCRIPTION OF THE DRAWINGS

FIG. 1 is a system schematic of a known ECU system configuration;

FIG. 2 is a schematic of several different known ECU system configurations;

FIG. 3 is a system schematic of an ECU system in accordance with the present disclosure;

FIG. 4 is a system schematic of an ECU according to the present disclosure employing discrete voltage increasing and decreasing;

FIG. 5 is a system schematic of an ECU of the present disclosure with variable voltage;

FIG. 6 is a block diagram of the cooling control in accordance with the present disclosure; and,

FIG. 7 is a block diagram of the cooling control system in accordance with the present disclosure alternatively employing a microprocessor.

### DETAILED DESCRIPTION

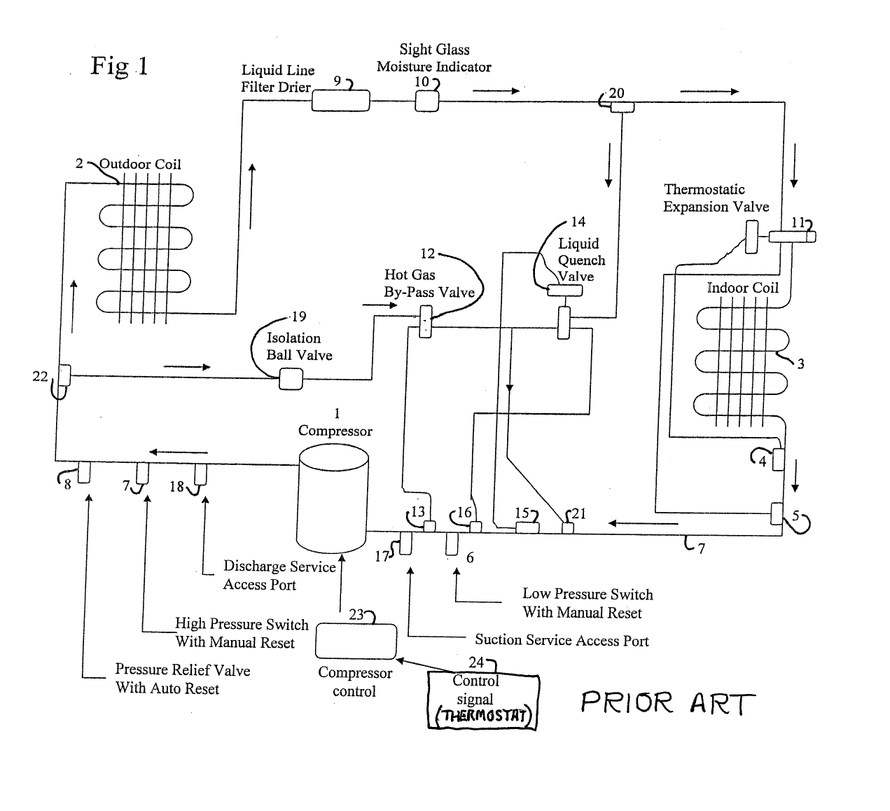

Referring now to FIG. 1 a known ECU system configuration is illustrated with a compressor 1, an exothermic heat exchanger or condenser 2 and an endothermic heat exchanger or evaporator 3 which can be disposed within a common enclosure; or, which can be configured as a split system. In FIG. 1, the compressor 1, the condenser 2 and the evaporator 3 are in a standard vapor cycle configuration. The compressor 1 supplies compressed refrigerant to the condenser 2, which is ambient air-cooled causing the refrigerant to be cooled and returned to the liquid state. The condenser supplies liquid refrigerant through a filter dryer 9 to a suitable expansion device such as a thermal expansion valve 11. The expansion valve 11 provides a restricted orifice that causes the liquid refrigerant to undergo a pressure drop and atomize into liquid droplets that are introduced into the inlet side of the evaporator 3. Expansion valve 11 is controlled by temperature sensing bulb 4, which senses evaporator discharge temperature; and, valve 11 is pressure compensated by a pressure tap 5 of the evaporator discharge pressure. The evaporator 3 acts as an endothermic heat exchanger and extracts heat from the surrounding airflow within the shelter to be cooled, thereby causing vaporization of the liquid refrigerant droplets in the evaporator into a gas. The compressor 1 extracts this gas by suction through return line 7 and again compresses it continuing the cycle. Diagnostic and service access is provided by a discharge service access port 18 and suction service access port 17.

In order to provide the compressor 1 with high temperature and pressure protection and system safety, additional components are specified by the compressor manufacture and the military. A high-pressure switch 27 is typically specified, with a manual reset, to shut the compressor off in the event of a restricted filter dryer 9, or insufficient refrigerant cooling of the condenser 2, that can be created by reduced airflow, such as caused by sand or dust restriction, or high ambient conditions. The high-pressure manually resettable switch 27, when tripped, will shut off the compressor, stopping the ECU from cooling until the operator manually resets the switch. This is by design, in order to require human operator maintenance action. The ECU operational manual usually instructs that, before manually resetting of the high-pressure switch 27, the condenser condition should be checked for blockage and cleaned as needed. The usual scenario is that the high-pressure switch 27 is repeatedly reset until maintenance personnel can clean the coil with pressurized air or water. A pressure relief valve 28 located in the compressor discharge line provides release of excessive system pressure and recloses when a safe pressure is established. A sight glass 10 between the filter drier 9 and an expansion device 11 provides a visual observation of the liquid charge and moisture state of the system and aids during servicing.

A low-pressure manually resettable switch 6 is specified to shut the compressor off, in the event of loss of system charge. More commonly, it will trip due to a frosted, frozen evaporator coil, due to airflow loss. Air flow restriction through evaporator 3 can be caused by the conventional air filter (not shown) being clogged with sand and dust. In many cases such air filter cannot capture or retain the dust due to its small size. Over time, the dust will clog the evaporator 3 and restrict the air flow through the evaporator. If the low-pressure switch 6 trips, the compressor will stop, preventing the ECU from cooling until the operator manually resets the switch. This requirement is by design, in order to require human operator maintenance action. The ECU operational manual usually instructs that, before manual resetting of the low-pressure switch 6, the condition of evaporator 3 be checked for blockage and the evaporator be cleaned, as needed. Also, the inlet filter and return ducts are checked for blockage or restriction. If no deficiency is found, gages are attached and the system is checked for low refrigerant charge level. The low-pressure switch 6 may be repeatedly reset until maintenance personnel can repair the ECU. The continual resetting of either the low pressure switch 6 or the high pressure switch 27 results in increased wear of the compressor. This, in turn, increases the power required to operate the compressor and creates excessive loads on the power supply generator. If either pressure switch is left tripped, no cooling is provided to the shelter.

In order to match cooling capacity to the load, an indoor temperature-sensing thermostat 24 cycles the compressor 1 on and off as required. This is not preferred, and in some cases not allowed when powered by mobile generators. Indoor thermostat 24 is then used as an on-off switch operating contactors 23 provided for compressor control. Contactors 23 may be wired to a soft start device or be used separately to cycle the compressor 1 on and off. Frequent compressor starting causes high compressor motor current draw which overloads the power grid creating line surges and low voltages.

Heretofore, it has been common practice in a typical ECU arrangement to match cooling capacity to the load by using a refrigerant by-pass system. In the FIG. 1 arrangement, a pressure or temperature sensor 13 modulates the hot gas by-pass valve 12 between a closed position and a full open position.

In the FIG. 1 arrangement, high pressure gas from the compressor 1 is diverted through a tee connection 22 and passes through an isolation ball valve 19 that is used for diagnostic function checks. Flow from valve 19 passes through hot gas by-pass valve 12, as needed, to the tee connection 21 into the compressor return or suction line 7, thereby reducing the flow through evaporator 3. This has the effect of lowering the heat adsorption capacity of the evaporator.

In addition to using a hot gas bypass valve 12, the prior art system of FIG. 1 uses a liquid quench valve 14, incorporated to cool the compressor inlet during very high load conditions in the evaporator 3. The liquid quench valve 14 is opened when the condenser 2 has reduced airflow from sand and dirt clogging. Reduced airflow through the condenser 2 increases the temperature of high-pressure liquid from condenser 2, which passes through expansion valve 11 to the evaporator. During high loading added thermal load to the evaporator 3 increases the evaporator discharge temperature in suction line 7. A temperature sensor 15 is disposed in line 7 to react to this temperature. It provides a signal for effecting opening of liquid quench valve 14, allowing by-passing of the evaporator 3 with high pressure liquid from tee connection 20 through liquid quench valve 14 to tee connection 21 in line 7. The by-passed high-pressure liquid cools the refrigerant in suction side line 7.

A high inlet temperature will over-heat the compressor 1 degrading its useful life. Temperature sensor 15 can also be located on the compressor outlet or inside the compressor.

Providing flow through valve 14 and cooling of compressor 1 prevents the compressor 1 from having to be cycled off, in order to not exceed the manufacturer's maximum inlet temperature recommendations. The hot gas bypass 12 and liquid quench valve 14 are shown as common methods of control.

Known ECU's require the ability to de-rate the capacity of condenser 2 and evaporator 3, and cool the compressor 1, in order to prevent compressor 1 from cycling on and off as loads change.

In the above described known system example, any time gas or high pressure liquid is diverted from the basic refrigeration cycle, efficiency is lost. The efficiency loss is the result of electrical power required for compressor operation during any by-pass function. This electrical power required for the compressor may become greater than the actual cooling effect.

An ECU employed for a military application is also more complex in operation than a commercial unit. This is due to the added field environment of sand and dirt loading on the coils. As coils experience reduced airflow, the system reacts to provide premature diversion of gas or high-pressure liquid.

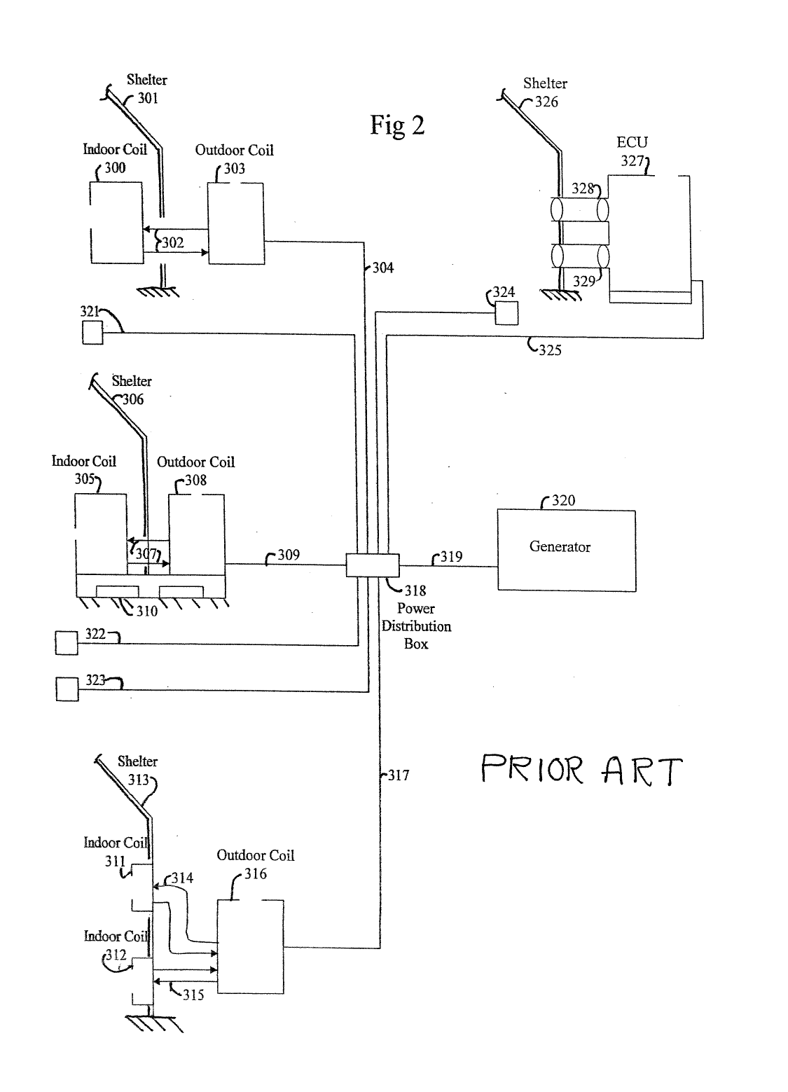

FIG. 2 illustrates a known system arrangement for plural shelters with an ECU 327. Various split system ECU's 303, 308, 316 are also shown. A split system is an ECU that has its components divided into two enclosures, having the indoor coil or evaporator and related components separated from the outside coil or condenser with its related components. This type of configuration eliminates outside ductwork heat losses. Depending on the type of configuration, it can reduce component weight sufficiently to eliminate the need for a forklift or similar positioning equipment and permit manual placement of the components. As is known, the components can be stand-alone or may be attached to internal air distribution or duct work as needed.

FIG. 2 is representative of known basic military configurations in which refrigerant and electrical connections 302 are passed through the shelter wall 301. The shelter wall 301 can be a hard or soft wall such as a tent. Indoor coil or evaporator 300 contains the evaporator coil and ventilation blower, with related refrigerant and electrical controls. Outside coil 303 contains the condenser coil, compressor and related refrigerant and electrical controls. The related refrigerant and electrical connections 302 are attached after placement of indoor coil 300 and outdoor coil 303.

A shelter 306 is shown in FIG. 2 having a soft wall and is shown elevated to allow pass-through of connections to an indoor coil 305. After positioning of the components, the soft wall 306 is lowered between indoor coil 305 and outdoor coil 308. Indoor coil 305 includes a ventilation blower with related refrigerant and electrical controls. Outside coil 308 includes a compressor and related refrigerant and electrical controls. The related refrigerant and electrical connections 307 are factory attached and routed to the common bottom frame 310. Both indoor coil 305 and outdoor coil 308 are mounted to the common bottom frame 310, which may be suitably configured for ready movement by a forklift.

Another shelter 313 may have a hard or soft wall with a first indoor coil 311 and a second indoor coil 312, each containing a ventilation blower with related refrigerant and electrical controls. An outside coil 316 includes a compressor and related refrigerant and electrical controls. The related refrigerant and electrical connections 314 and 315 are routed through shelter wall 313 and attached after placement of indoor coils 311, 312 and outdoor coil 316. Indoor coils 311, 312 can be of a window mount style to provide for fresh air make up flow, mounted to an inside wall, or can be placed on the floor or an elevated stand.

Another shelter 326 may have a hard or soft wall. The supply and return air flow from ECU 327 is connected to the shelter 326 by flexible or rigid duct work 328, 329.

FIG. 2 depicts an arrangement using an electrical generator 320 and may comprise a single or plural generators connected to power distribution box 318 instead of local supply grid power for illustration of a generator application.

Generator 320 is connected to a power distribution box 318 by power cable 319. The power distribution box 318 supplies power through cable 304 to the compressors and fan motors associated with indoor coil 300 and outdoor coil 303 and power for other uses in shelter 301, through power cable 321.

In addition, power distribution box 318 supplies the compressors and fan motors for indoor coil 305 and outdoor coil 308 through power cable 309. Power for other uses in shelter 306 is supplied through power cable 322.

Power distribution box 318 also supplies power to the compressors and fan motors associated with indoor coils 311, 312 and outdoor coil 316 through power cable 317. Shelter 313 is supplied through power cable 323 for its other uses.

Power distribution box 318 also supplies ECU 327 through power cable 325. Other electrical uses for shelter 326 are supplied through power cable 324.

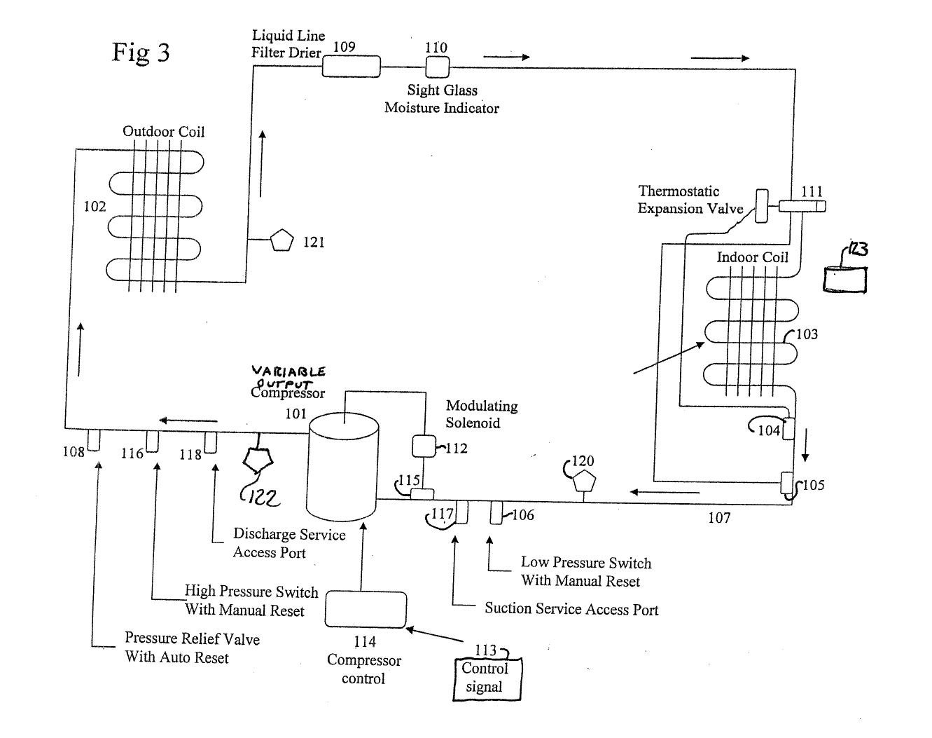

FIG. 3 illustrates an ECU of the vapor cycle type configured to employ the subject matter of the present disclosure. In contrast to the systems of the type illustrated in FIG. 1, the system of FIG. 3 reduces plumbing complexity, the potential for refrigerant leaks, the skill needed for diagnostics and repair, the number of spare parts to stock, and the losses created from gas or high-pressure liquid diversion.

In FIG. 3, a variable output compressor 101, condenser 102 and evaporator 103 may be disposed within a common enclosure. Alternatively, it is configured as a split system arrangement, such as depicted in FIG. 2.

In the FIG. 3 embodiment, the variable output compressor 101, the condenser 102 and the evaporator 103 are in a common case configuration. The variable output compressor 101 supplies pressurized refrigerant gas to the condenser 102, which is ambient air-cooled to effect condensation of the refrigerant. The condenser 102 supplies liquid refrigerant to a filter drier 109. The filter drier 109 in turn supplies refrigerant flow through a sight glass and moisture indicator 110 to a suitable expansion device such as a thermal expansion valve 111. The expansion valve 111 may be of the type employing a restricted orifice that causes the liquid refrigerant to atomize into liquid droplets, which are subsequently introduced into the inlet side of the evaporator 103. Expansion valve 111 may be of the type controlled by a temperature sensing bulb 104 and pressure compensated by connection to a pressure tap 105 connected to receive evaporator discharge pressure. The evaporator 103 endothermically extracts heat from the surrounding airflow and effects vaporization of the liquid refrigerant droplets therein into a gas. The variable output compressor 101 extracts this gas from the evaporator by its inlet suction and then compresses it back into a high pressure state. The pressurized refrigerant is then cooled in the condenser 102, condenses to liquid and is returned back to the filter drier 109, and expansion device III where the cycle continues.

A pressure switch 116 is disposed on the compressor high pressure or discharge line and shuts off the compressor 101 when the maximum allowable design pressure is exceeded. Another pressure switch 106 is disposed in the low pressure or evaporator suction return line 107 and shuts off compressor 101 when the pressure in line 107 is below allowable design suction pressure. A pressure relief valve 108 is set to release excess refrigerant pressure if maximum allowable design pressure is exceeded, e.g. an over pressure condition is sensed. Valve 108 automatically recloses when normal pressure resumes. A service access port 118 is provided in the compressor high pressure discharge line; and, a suction service access port 117 is provided in the suction line 107, both for facilitating diagnostic and refrigerant servicing.

The prior art system of FIG. 1 employs hot gas by-pass and liquid quench to manage capacity. In contrast, the presently disclosed system shown in FIG. 3 does not use these aforesaid capacity control techniques.

Instead, the ECU refrigeration system of FIG. 3 employs a compressor 101 that is of a variable capacity design and is managed by a control 114 that may be either an inverter that controls the speed or Rpm of the compressor 101 for changing its capacity. Alternatively, compressor control 114 may be a digital control that generates the loaded and unloaded signal, effecting changing the capacity of compressor 101. Both types of compressor control 114, by design, provide the lowest capacity when required, while maintaining sufficient oil flow through compressor 101. A control signal 113 may be a variable DC voltage which by voltage value change causes compressor control 114 to change the compressor capacity output.

An inverter driven compressor may be employed, but has the disadvantage of being difficult to fault diagnose and costly to shield compared to a digitally controlled compressor. If an inverter driven compressor is employed, the variable voltage hereinafter described is connected to the variable voltage input terminals of the compressor inverter drive.

The following describes an embodiment of the present system in which an electrical control operates a digital compressor drive to create a compressor control signal. The variable output signal is connected to the variable voltage input terminals of the compressor drive.

FIG. 3 depicts a compressor 101, managed by a modulating solenoid 112. Modulating solenoid operated valve 112 is connected to a tee connection 115 and is operative to supply the pressure changes needed to move internal components of compressor 101, for changing the output capacity of the compressor. The compressor capacity modulation can be any combination of full flow, reduced flow, or a no flow. Modulating solenoid 112 may be replaced by an electro magnet that is positioned on or within the compressor. The electro magnet may be operative to move the internal capacity control components of the compressor to modulate the flow instead of using gas pressure. The electro magnet may be controlled by an electrical control signal and be cycled between an “on” or an “off” state depending on the capacity requirements of the compressor 101. Either of the “on” or “off” states of the electrical control signal may effect movement of the compressor internal capacity control components for effecting lowest or highest capacity output.

A sensor 120 is disposed in evaporator discharge line 107 and may be a pressure or temperature source that provides suction side or evaporator discharge signals. A sensor 121 is disposed in the condenser discharge line and may be a pressure or temperature source that provides high-pressure side or condenser discharge signals. Another sensor 122 may be disposed in the compressor discharge line and may be a pressure or a temperature source that provides compressor discharge signals. A thermostat 123 is disposed to provide conditioned air temperature regulation signals for the air in the shelter.

Heretofore, ECU's operated in fielded operational climatic conditions encountered in military applications have not proven satisfactory because of component deficiencies. Also, known air conditioning systems have previously been operated by compressor on-off cycling.

In such a known system, the pressure switch 116 and pressure switch 106 were connected to compressor control 114. Compressor control 114 turned off compressor 101 during an excessively low or high-pressure occurrence. In such prior art systems, no provisions were made to provide variable compressor capacity control based on high side pressures. As discussed earlier, neither hot gas by-pass, liquid quench, nor similar hydraulic control devices are used in an ECU to modulate capacity based on the high-pressure side.

Referring to FIG. 3, the presently disclosed system integrates a variable capacity compressor, such as compressor 101, and compressor control 114 with a single variable voltage signal that is the sum of a pressure sensor signal, a temperature sensor signal (such as a signal from the suction pressure or temperature sensor 120 signal, a signal from the high-pressure sensor 121 and a signal from the compressor discharge pressure or temperature sensor 122) with a signal from thermostat 123. The present system accomplishes control without the use of a proportional-integral-derivative controller (PID) or similar type controller device. This single variable signal is connected to the thermostat input of the compressor control 114. The variable voltage provided to the thermostat is operable to sustain, increase or decrease the capacity of the compressor 101.

The benefit of a single control input is that the digital controller or inverter (depicted as compressor control 114) can be driven with only one connection that is the summation of many sensors. A single variable voltage connection is easier to diagnose. The compressor controller can be made less expensive, as, the pressure and temperature sensors do not have to terminate at the compressor controller. In addition, each sensor input requires software and in this embodiment custom software for operation. Thus the compressor controller 114 becomes application specific, resulting in higher cost and decreased availability as compared to an off-the-shelf readily available compressor controller 114. By using the single thermostat input, the total system capacity can be regulated to the maximum coil capacities during extreme high ambient conditions, such as caused by sand and dust loading of coils or an improperly sized shelter air distribution system.

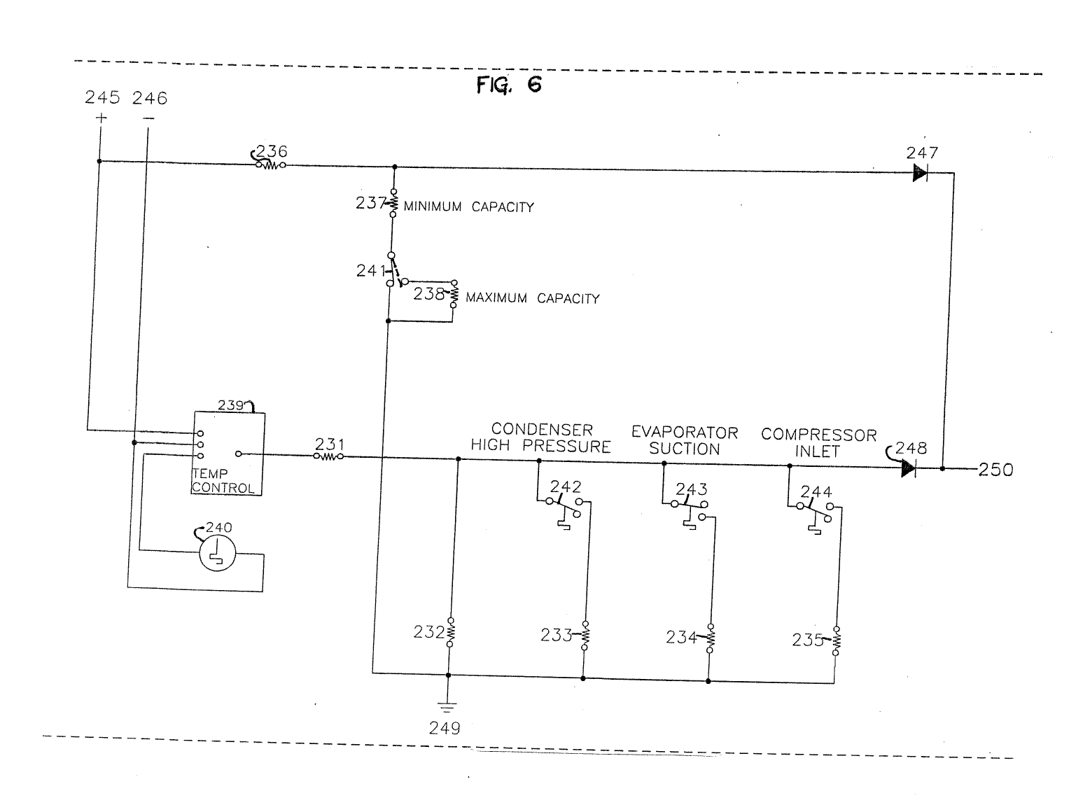

This voltage control is based upon the fact that a condenser high pressure and a evaporator low pressure will not occur at the same time. Only one sensor at a time will be operational in the circuit, except for the thermostat. In the event that a condenser high pressure and compressor high temperature signal occurred at the same time, the voltage would modulate between the two or be the sum of these two inputs further reducing the regulation of the compressor. If the thermostat is calling for reduced compressor capacity, it is unlikely that any other sensor would be active. FIG. 6 shows how the circuit is managed if a sensor becomes active during a thermostat call for less capacity. An ECU will not have a high-pressure condenser condition and an evaporator suction pressure low temperature condition at the same time.

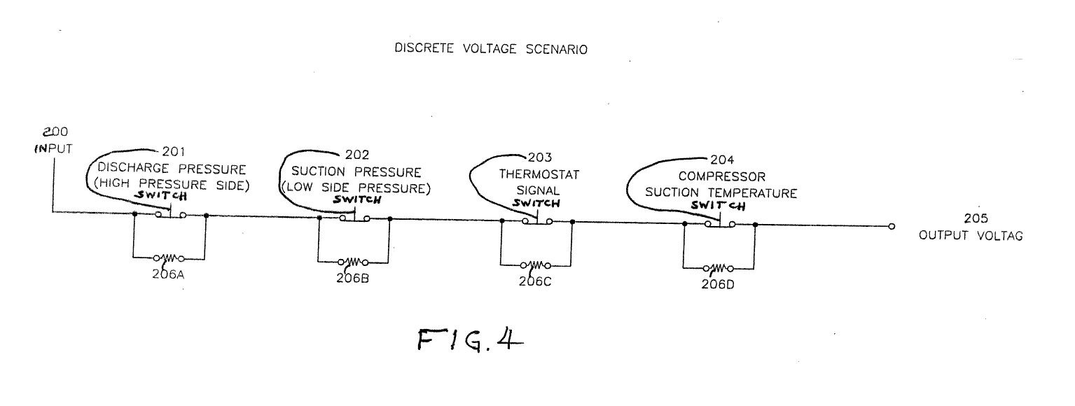

FIGS. 4, 5, 6 show the details about how a variable DC voltage can be produced and by circuit resistance, regulated to control system capacity.

FIG. 4 shows an arrangement in which a discrete (stepped) voltage is employed to generate a variable voltage output. The voltage applied to input 200 is determined by the compressor controller voltage requirements and may be, for example, a 5 or a 10 volt dc signal. For this example 0 to 5 volts is used. The output voltage 205 remains high at 5 volts, for compressor full capacity output when discharge pressure switch 201, suction pressure switch 202, thermostat switch 203 and compressor suction temperature sensor switch 204 are closed. Resistors 206a through 206d are shunt resistors for switches 201-204 and have the respective resistance values thereof selected to provide the desired voltage output for effecting the desired compressor capacity when their respective sensor contacts are open. A reduced capacity voltage level occurs when the discharge pressure switch 201, senses a predetermined pressure, causing the switch to open and putting resistor 206a in the circuit. If the value of 206a is selected to provide 4 volts, a 4 volt output voltage 205 is applied to the compressor controller thereby causing the controller to move the compressor control components to effect reducing the compressor capacity and lowering the discharge pressure, in turn preventing high pressure switch 116 in FIG. 3 from effecting compressor shut off. This relatively simple capacity control circuit is not only reliable, but is simple to diagnose and repair in the field. This system thus saves electrical operating cost when compared to a hot gas by-pass system and also reduces capacity during high ambient conditions and when the condenser coil cooling airflow is restricted by clogging with sand and dust.

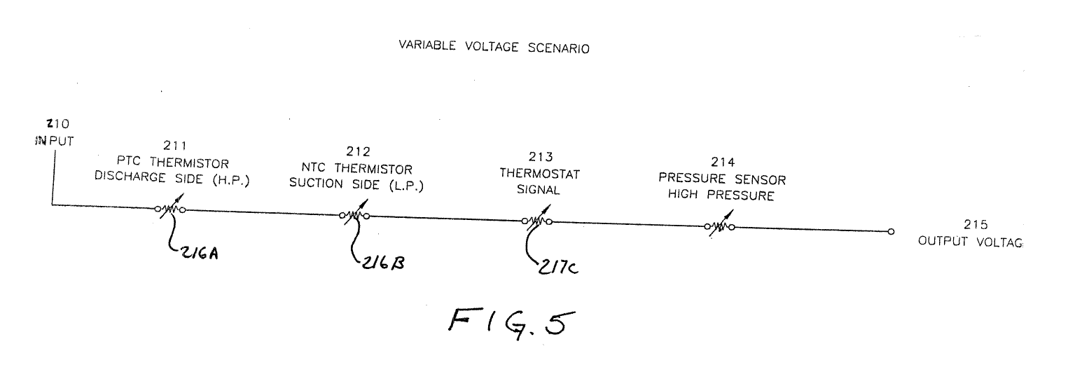

FIG. 5 shows an embodiment of the present system wherein the voltage applied to input 210 is determined by the compressor controller and thermostat voltage requirements. Output voltage 215 is controlled by selection of the values for variable sensor resistors 216a, 216b, 217c series connected with the high pressure sensor 214 to provide a control signal. Positive or negative coefficient temperature and pressure sensors may be employed for sensors 211-214. A positive temperature or pressure coefficient resistor may be employed to give an increase in resistance on increase of pressure or temperature; and, a negative coefficient resistor may be employed to give a decrease in resistance on reduced pressure or temperature change.

For this example, a positive temperature coefficient (PTC) thermistor 216A employed in discharge side sensor 211 increases in resistance as the compressor discharge temperature rises. The increased resistance lowers the voltage of the control signal, which in turn effects compressor component movement for reducing the compressor output. The resistance of thermistor 211 continues to increase until the compressor discharge temperature begins to lower. As the compressor discharge temperature lowers, the resistance lowers effecting movement of the compressor components for increasing the compressor capacity. The sensor 211 may be placed on the high-pressure outlet of the compressor. This location and function thus provides the same compressor protection as liquid quench valve 14 of the Prior Art system of FIG. 1, but is simpler, less costly and more reliable.

A negative temperature coefficient (NTC) thermostat is employed in suction side sensor 212, which has a negative coefficient thermistor 216b built in. As the temperature decreases, the resistance of 216b will increase, thereby lowering the output voltage 215. As the control signal 215 voltage is reduced, the compressor control components will be moved and compressor capacity decreased, reducing cooling system capacity. This type of sensor may be placed at the evaporator discharge location to prevent evaporator freeze up, due to low airflow caused by a coil or filter clogged by sand or dust or from shelter ducting which does not provide adequate airflow.

Thermostat signal sensor 213 may be of a snap action type. As depicted in FIG. 4 thermostat 203 may be of the type that uses a preset resistive value, or may be a commercially available thermostat that supplies a variable output voltage. Different styles are available providing many options, for example, from those using a set point to those providing user choice of degrees off set point.

Referring to FIG. 5, pressure sensor 214 is disposed to sense compressor discharge, or high side pressure. It has a positive coefficient resistance built in. As the pressure increases, the resistance increases thereby reducing output signal voltage 215. This causes the controller to effect movement of compressor components and reduces the compressor capacity. Sensor 215 may be placed after the condenser and before the filter drier. Such a location for sensor 215 offers protection from the situation in which flow through the filter drier becomes restricted. More importantly, a sensor so located effects a reduction of compressor capacity during periods of extreme high ambient temperatures, or when the condenser has experienced reduced cooling airflow from sand and dust clogging. Reducing the compressor capacity prevents compressor over pressure and resultant compressor shut-off by the overpressure sensor 214.

Referring to FIG. 6, another embodiment is shown wherein control power at terminals 245, 246 is supplied to a temperature control device 239. Also, a signal based on a temperature sensor 240 is outputted to the compressor controller 250 through resistor 231 after passing through interface circuitry and passing through a diode 248. The interface circuit consists of three circuits which tune the control for various functions.

The first circuit includes series resistor 231, and parallel resistor 232, and drops the output of the control device 239 to a level that is acceptable to the compressor controller 250.

The second circuit, comprising parallel resistors 233, 234, 235, is brought into effect as required by closure of any of the individual system condition switches 242, 243, 244, respectively. These are operative to lower the output signal to the compressor controller to reduce output capacity of the compressor.

The first and second circuits comprise the variable capacity control. In the event a component failure occurs in either of the first or second circuit and an open circuit is created at diode 248, the third circuit 241 (bottle) switch voltage is applied to output 250. The third circuit comprises series resistor 236, and parallel resistors 237, 238. When the switch 241 is in its normal position as shown in FIG. 6, the circuit uses resistors 236, 237 and is operable to supply a minimum operating signal to diode 247. As long as the potential at diode 248 is higher, the minimum operating signal is blocked at diode 247. When the switch is in bypass mode, shown in dashed line in FIG. 6, the circuit uses resistors 236, 237 and 238 in circuit and a maximum operating signal is outputted at 250 to keep the compressor running at full capacity without regard to the first and second circuit. Diodes 247 and 248 are employed to insure that the highest voltage potential is always supplied to output 250.

In one embodiment, it has been found operable, for example, to connect output 250 to a Copeland Scroll Digital Compressor Controller part number 543-0024-00. This type of Controller may be employed in the electronic interface between a Copeland Scroll Digital Compressor, such as the ZPD series. However, it will be understood that various types of electronic interfaces may be employed depending on the type of variable capacity compressor, i.e. whether rotary, piston or scroll. This circuit, output 250 connects to the connection points for a variable thermostat voltage. When using the Copeland Scroll Digital Compressor Controller thermostat input, a voltage below 1.4 volts cycles the compressor off. A 1.4 volt to 5 volt variable input controls the compressor capacity from 10% to 100%.

With further reference to FIG. 6 resistors 233, 234, 235 can be manually variable resistors to aid in testing. During initial calibration of the ECU, these resistors may be manually adjusted for maximum or minimum pressures and or temperatures of the compressor, condenser, and evaporator. The calibration may be preformed within a controlled ambient-psychrometric test chamber. The various climatic conditions that the ECU would be subjected to when fielded thus may be simulated, including restricted coil airflows. After calibration, variable resistors 233, 234, and 235 may be potted and left as adjusted. If desired for robustness, fixed resistors may be used. For increased performance and efficiency, pressure transducers or temperature thermistor type sensors may be utilized. Variable type sensors may be ordered with the resistance curve selected to fit the capacity control needed for each coil and for compressor discharge temperature protection. Additional sensors may be employed if desired and different locations may be used for the sensor as needed within the control strategy described herein.

Referring to FIG. 6, other combinations of pressure and or temperature sensors may be used. For example, if high-pressure switch 242 is set to close at 240° F., putting resistor 233 in the circuit, the voltage drop, determined by resistor 233, reduces compressor capacity control signal to a known voltage value, until high-pressure switch 242 opens for example at 225° F. removing resistor 233 from the circuit. If suction switch 243 is set to close at 30° F. putting resistor 234 in the circuit, the voltage drop, determined by resistor 234 reduces compressor control signal capacity to a known voltage value until suction switch 242 opens at 40° F. removing resistor 234 from the circuit. The process of increasing and decreasing the voltage continues with compressor inlet temperature switch 244 set to close at 65° F., putting resistor 235 in the circuit, the voltage drop, determined by resistor 235, reduces the compressor capacity control signal to this voltage value until inlet suction switch 244 opens at 55° F. removing resistor 235 from the circuit.

Thermostat 239 may be a Johnson Control A350P proportional temperature control that supplies a 10 to 0 volt DC output. Resistor 231 and resistor 232 fixed values may be selected to lower the voltage from 10 to 0 to a 5 to 0 volt potential DC for compatibility with a 5 volt DC compressor electronic interface control. Thermostat 239 increases or decreases the voltage output in relation to sensor 240 and the manually selected temperature set point. When temperature control thermostat 239 calls for maximum cooling, a 5 volt signal is supplied to output 250. When no cooling is required, the voltage drops to 0 volts. A 0 volt output signal 250 to the electronic interface turns off the compressor.

As stated previously it is desirable that an ECU not provide temperature regulation by cycling the compressor on and off. When the switch 241 is in the normal position shown in solid line in FIG. 6, the circuit 236, 237 supplies minimum operating signal to keep the compressor running at the lowest capacity. A 10 percent ECU capacity output in most ECU applications will not over cool the shelter due to heat loss, fenestration, equipment or personnel. The compressor control 114 of the FIG. 3 embodiment and the compressor control voltage 250 may be employed to effect operation of an actuator for moving a member in a mechanically variable capacity compressor, or operable to effect varying compressor speed in an electrically controlled variable speed compressor drive. If desired, an on/off line switch may be incorporated to shut off the compressor when needed.

In addition to the circuitry illustrated in FIGS. 4-6, it should be appreciated that a microprocessor could be employed to regulate the operation of the variable output compressor 101 illustrated in FIG. 3. Thus, the compressor control 114 could be a microprocessor which receives the inputs of the various sensors and switches shown in FIG. 3.

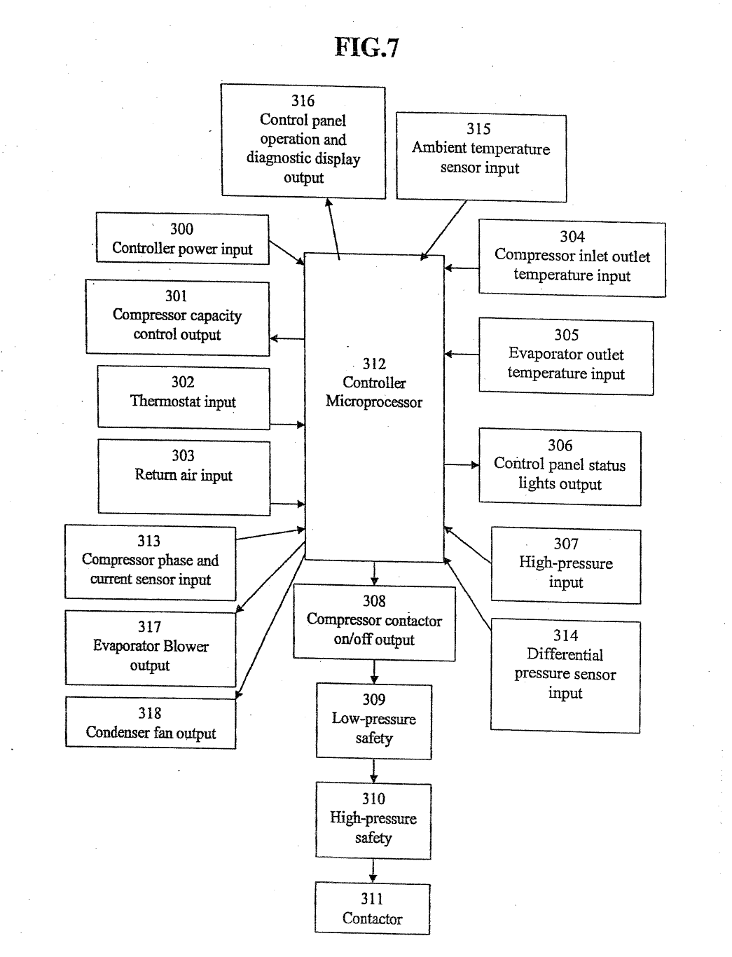

Referring to FIG. 7, a microprocessor form of circuitry is shown which may be employed in the present method with the ability to provide minimum RPM or non-pump time for oil control is that supplied by the compressor manufacture. Compressor rotor speed or minimum pump time may also be managed within the program. Values above the minimum are the available capacity control of the compressor. The evaporator and condenser load, the ambient temperature and coil condition may be calculated based on input and output sensor signals and system reaction to the current capacity output signal. Information regarding degradation of coils due to clogging or a restricted evaporator filter may be provided to the operator for corrective action. In addition, low voltage line frequency or phase loss may be readily analyzed and the proper system response provided. Custom microprocessors that have all the logic functionality and input/output variable control ability to operate an ECU are commercially available.

In FIG. 7, microprocessor 312 may be a micro based system with analog to digital conversion, timer functions, non-volatile memory, an onboard power supply, watchdog function comparators and supportive hardware. Microprocessor 312 analyzes the variable resistance inputs from voltage, current, cycle, pressure and temperature sensors and provides the maximum compressor capacity based upon the thermostat set point and component condition, while providing prognostic and diagnostic functions to the operator. In addition to operator function status alerts in the event a system component began to operate outside of its predetermined safe operation level, a system shut down would occur preventing any safety issues or component damage and would provide the operator with the reason for shut down using the control panel 316 diagnostic display.

Referring to FIG. 7, when the operator first selects cooling, the microprocessor 312 is supplied with controller power input 300. Microprocessor 312 will set any internal values and then perform a pre-start routine consisting of a wire harness-to-component continuity check to insure key sensors are functioning, that proper electrical power is available from compressor phase and current from compressor phase and current sensor 313 that the wire harness is connected properly. Upon successful completion of the pre-start, a start routine is initiated. A reading of the thermostat 302 value is taken; and, if there is a call for cooling the evaporator blower 317 and condenser fan 318 are turned on then readiness of differential pressure 314, return air 303 and ambient temperature 315 are taken. If the differential pressure 314 across the evaporator (pressure drop) is within preset minimums, contactor 311 is energized by the compressor contactor on/off output 308 through the low-pressure safety 309 and through the high-pressure safety 310. Compressor capacity control output 301 starting voltage level is determined by means of a software look up table, using the ambient temperature sensor 315 and return air 303 inputs. This is to provide an initial stabilization capacity to prevent excessive high-pressure upon first starting with heat soaked components and prevailing loads.

The run routine is initiated and compressor inlet outlet temperature 304, high pressure 307, and evaporator outlet 305 readings are taken. Data derived from testing performed within a controlled ambient-psychrometric chamber is employed to provide the operational control and hysteresis of capacity changes of the ECU vapor cycle. This data provided within a controlled ambient-psychrometric chamber is employed to provide the operations control and hysteresis of capacity changes of the ECU vapor cycle. This data is provided within the memory of microprocessor 312. The microprocessor 312 is operational to increase or decrease the compressor capacity voltage 301 to best match the cooling capacity to component condition and thermostat input 302 set point. The control panel 316 may present the operator with the on/off status and any user preferred information such as ambient and indoor temperature, amperage draw, and the capacity the unit is currently producing to name a few. In addition to the current ECU status information on component degradation such as a clogging evaporator filter or restricted condenser airflow can be provided to the operator for scheduled maintenance. It will be understood that variations of the operation sequences, number of sensors, and level of prognostic and diagnostics may be employed to provide reliable operation and provide notice of need for repair depending upon the application.

The disclosure herein has been described with reference to the preferred embodiments. Obviously, modifications and alterations will occur to others upon reading and understanding the preceding detailed description. It is intended that the disclosure be construed as including all such modifications and alterations insofar as they come within the scope of the appended claims or equivalents thereof.

1-6. (canceled)

7. A method of controlling refrigerant circulating through a variable capacity compressor, an exothermic heat exchanger, an expander, an endothermic heat exchanger and return comprising:
(a) sensing a refrigerant condition on the compressor high side;
(b) sensing a refrigerant condition on the compressor low side; and,
(c) reducing the compressor variable capacity when an overload condition is sensed in one of steps (a) and (b).

8. The method described in claim 7, wherein the step of sensing a refrigerant condition on the compressor high side includes sensing one of refrigerant pressure and temperature.

9. The method defined in claim 7, wherein the step of sensing a refrigerant condition on the compressor low side includes sensing one of pressure and temperature.

10. The method defined in claim 7, wherein the steps of sensing include:
(a) generating an electrical control signal indicative of the sensed condition; and,
(b) the step of varying compressor capacity includes disposing a servomechanism receiving the electrical control signal and moving a control member in the compressor.

11. The method defined in claim 7, the step of sensing a condition of the refrigerant on the compressor high side includes sensing a condition intermediate the expander and the endothermic heat exchanger.

12. The method defined in claim 11, wherein the step of sensing a refrigerant condition intermediate the expander and the endothermic heat exchanger sensing one of temperature and pressure.

13. The method defined in claim 7, wherein the steps of changing the compressor variable capacity includes:
(a) connecting an electrically operated actuator to the compressor;
(b) generating a low capacity control signal in response to sensing an overpressure or the compressor high side; and,
(c) applying the low capacity control signal to the actuator and varying the compressor for lowest capacity.

14. The method defined in claim 13, wherein the step of generating a control signal includes disposing at least one pressure switch and changing circuit resistance upon actuation of the pressure switch.

15. The method defined in claim 13, wherein the step of generating a control signal includes disposing a thermistor in circuit and varying the resistance in response to sensed refrigerant temperature.

16. The method defined in claim 13, wherein the step of generating a control signal includes sensing the air temperature in the area to be cooled.

17. The method defined in claim 7, wherein the step of sensing a high-side condition includes sensing compressor discharge temperature.

18. The method defined in claim 7, wherein the step of changing the compressor capacity includes changing the compressor speed.

19-23. (canceled)
